(19) United States
(12) Patent Application Publication
(10) Pub. No.: US 2023/0097316 A1
(43) Pub. Date: Mar. 30, 2023

(54) SOOTHER

(71) Applicant: Mayborn (UK) Limited, Newcastle Upon Tyne (GB)

(72) Inventors: Benedict Calland, Newcastle Upon Tyne (GB); Joshua Hume, Newcastle Upon Tyne (GB)

(21) Appl. No.: 17/904,064

(22) PCT Filed: Feb. 11, 2021
(86) PCT No.: PCT/GB21/50329

§ 371 Date: Aug. 11, 2022

(30) Foreign Application Priority Data
Feb. 13, 2020 (GB) 2002008.7
Sep. 11, 2020 (GB) 2014333.5

(51) Int. Cl. A61J 17/00

(52) U.S. Cl. CPC A61J 17/001; A61J 17/10

(57) ABSTRACT

The present invention relates to a soother, as well as a method of manufacturing a soother, including a curved shield and a mouthpiece arranged for insertion into an infant's mouth. The mouthpiece extends away from a substantially convex side of the shield along a central axis of the shield so that a first end is adjacent to the shield and a tip is distal from the first end. The shield and the mouthpiece each have an axial length and the soother is configured so that its centre of gravity is in a region which extends from the tip of the mouthpiece, along the axial length of the mouthpiece and along up to 50% of the axial length of the shield. In a second embodiment, the soother is configured so that its centre of gravity is in a region lies which extends from an innermost limit of the shield along up to 50% of the axial length of the shield.

The present invention relates to an infant soother, in particular an infant soother including a shield.

### INTRODUCTION

Conventional soothers, sometimes referred to as dummies or pacifiers, are formed of a teat, also known as a nipple or baglet, which is sucked by a child and a shield or ring on which the teat is mounted to prevent the infant from choking on the teat. A common form of soother includes a multi component assembly wherein the teat, formed of silicone, is formed with an assembly of parts. One known soother arrangement is shown in FIGS. 1a and 1b. A soother includes a teat 1, a hard shield 2 shaped around a central axis (see FIG. 1a) so that the shield curves towards the teat and hence curves towards an infant's face when the teat is in the infant's mouth. The soother also includes a cover 5, and a plug 4 which traps a flange 6 of the teat 1 against the shield 2 to prevent removal of the teat 1 from the shield 2 by pulling.

Soothers are also known in which the teat is mounted to the shield by over-moulding instead of trapping, for example as described in WO2009053699. Whilst the method of mounting the teat differs, the soother shield and teat have many features in common with the plug and cover type.

As soothers are small devices that go into the mouths of babies and infants, the national and international standards for factors such as strength and non-deformability of soothers are very strict. Standards also specify the range of sizes of any openings or apertures in the shield, to ensure they are not finger traps and that air can circulate therethrough should the device inadvertently become trapped in an infant's mouth.

Conventional teething devices or teethers are formed of a shaped teething part, for example a resilient U-shaped portion that an infant can chew on, and a shield to which the teething part is mounted. As teethers are also small devices that go into the mouths of babies and infants, the same or very similar standards and design requirements as apply to soothers may also apply to teethers.

As used herein, the term “soother” is to be understood to include devices which are known as a comforter, teether, teething device, soother, dummy or pacifier. The teat, nipple, baglet or teething part of such devices may each be referred to as a mouthpiece. Soothers commonly include rigid shields to support a mouthpiece.

Known soothers include shields that are sized and shaped so that when an infant sucks on the mouthpiece the shield wraps around the area of the face around the mouth. This arrangement helps prevent the shield entering the infant's mouth but can mean the shield contacts the face, thereby applying unwanted pressure to the lips and surrounding areas of the face.

Furthermore, infants often drool or dribble and, due to the wrapping shape, the close proximity of the shield to the face causes moisture to become trapped between shield and skin. Moisture from exhaled air from the nose and mouth may also build up and become trapped in the same location. This trapped moisture often causes skin irritation around the user's mouth which may be unsightly and sensitive, potentially meaning the infant has to stop using the soother for a time in order to allow their skin to recover.

It is known in the art to provide ventilation holes through a shield, which are primarily a safety feature to ensure the shield does not obstruct a mouth or airway should a soother become partially lodged in an infant's mouth. Although such holes may have a secondary effect of allowing air to reach small regions of the face when the soother is being used correctly, they are unable to prevent moisture becoming trapped between the surrounding shield portions and the user's skin.

### SUMMARY OF THE INVENTION

According to a first aspect of the invention, there is provided an infant soother comprising:
a curved shield having a central axis extending therethrough,
a mouthpiece extending from a substantially convex side of the shield and along the central axis, for insertion into an infant's mouth, wherein the mouthpiece comprises a first end adjacent to the shield and a tip distal from the shield;
wherein the shield and the mouthpiece each have an axial length, and
wherein the soother is configured such that a centre of gravity of the soother lies in a region which extends from the tip of the mouthpiece, along the axial length of the mouthpiece and along up to 50% of the axial length of the shield.

Aptly, the shield includes a centre portion with the central axis therethrough, first and second side portions opposingly arranged either side of the centre portion, and a shield edge region distal from the centre portion. In certain embodiments, the mouthpiece is mounted to the centre portion of the shield.

Aptly, the first side portion is configured to curve away from the mouthpiece towards a first section of the shield edge region, and the second side portion is configured to curve away from the mouthpiece towards a second section of the shield edge region.

Aptly, each of the first and second sections of the shield edge region are angled away from the mouthpiece at an angle of at least 120° with respect to the central axis. Aptly, at least one section of the shield edge region slopes away from the mouthpiece at an angle of from 130° to 160° with respect to the central axis. Aptly, a surface of the shield adjacent to the mouthpiece is substantially convex.

In this way, the shield provides ventilation between the infant's skin and the shield because there is no longer a moisture trap due to the close proximity of the inner surface of the shield and the infant's skin. Thus, drool or dribble from the infant's mouth does not stick between the face and the inner surface of the shield and can be easily wiped away or can easily evaporate. Also, moisture in the air from the infant's nose and mouth is able to flow freely away from the face.

The angled sections of the shield edge region also provide the shield with structural rigidity because their respective curvature gives the shield strength in more than one direction.

The increased rigidity provides further advantages in the soother design, because the greater strength allows for larger air-holes in the shield and hence the effective surface area of the shield may be minimised and weight may be reduced.

The improved ventilation and increased rigidity provided by the angled sections may be amplified by incorporating such sections on more than one radial segment of the shield. Thus, advantages for the shield design may apply equally in subsequent cross-sectional directions and the advantages on the shield as a whole may be reinforced.

With increased shield rigidity, the shield may be substantially lighter by making the shield thinner or providing air holes which comprise a large proportion of the shield area. Thus, the centre of gravity of the soother may be positioned towards the face of the user when they are sucking the mouthpiece. Accordingly, the soother may be more easily retained in the mouth.

Aptly, the shield further includes a substantially concave side, opposingly arranged to the substantially convex side.

Aptly, the substantially concave side includes one or more: a series of ribs, a series of channels or grooves, a series of projections or a region of discontinuous materials such as a honeycomb or the like. Aptly, the curved shield comprises at least one air hole extending therethrough. Aptly, each air hole each has a cross-sectional area and wherein the aggregate cross-sectional area of the air holes is at least 25% of a footprint area of the shield. Aptly, the substantially concave side includes at least one reinforcing rib. Aptly, the mouthpiece is weighted such that a weight of the mouthpiece is greater than a weight of the shield.

In these ways, the shield may be further reduced in thickness or area without losing strength or structural integrity. The soother may thus be configured so that the centre of gravity is disposed at or near the mouthpiece thereby making it easier for an infant maintain the soother in their mouth.

Aptly, the curved shield is a rigid frame co-moulded or over-moulded with a flexible material.

Aptly, the flexible material also forms at least one of the mouthpiece and a handle.

Aptly, at least the mouthpiece and the shield are formed as unitary part.

Aptly, the centre of gravity lies in a region which extends along up to 35% of the axial length of the shield. In certain embodiments, the centre of gravity lies in a region which extends along up to 25% of the axial length of the shield.

Aptly, the axial length of the shield is at least 10 mm. In certain embodiments, the axial length lies in a range of 10 mm to 20 mm.

In these ways, the shield may be configured so that it provides ventilation to the user's skin while ensuring that the centre of gravity lies in a region at or near the mouthpiece.

According to a second aspect of the invention, there is provided an infant soother including:
a curved shield having a central axis extending therethrough,
a mouthpiece extending from a substantially convex side of the shield and along the central axis, for insertion into an infant's mouth, wherein the mouthpiece includes a first end adjacent to the shield and a tip distal from the shield;
wherein the shield has an axial length extending between innermost and outermost axial limits, and
wherein the soother is configured such that a centre of gravity of the soother lies in a region which extends from an innermost limit of the shield along up to 50% of the axial length of the shield.

According to a third aspect of the invention, there is provided a method of manufacturing an infant soother, the method including:
forming a curved shield having a central axis extending therethrough,
mounting a mouthpiece to a substantially convex side of the shield and along the central axis, for insertion into an infant's mouth, wherein the mouthpiece includes a first end adjacent to the shield and a tip distal from the shield;
wherein the shield and the mouthpiece each have an axial length, and
wherein the soother is configured such that a centre of gravity of the soother lies in a region which extends from the tip of the mouthpiece, along the axial length of the mouthpiece and along up to 50% of the axial length of the shield.

According to an aspect of the disclosure, there is provided an infant soother including:
a shield including a centre portion with a central axis therethrough, first and second side portions opposingly arranged either side of the centre portion, and a shield edge region distal from the centre portion;
a mouthpiece mounted to the centre portion for insertion into an infant's mouth;
wherein the first side portion is configured to curve away from the mouthpiece towards a first section of the shield edge region, and the second side portion is configured to curve away from the mouthpiece towards a second section of the shield edge region; and
wherein each of the first and second sections of the shield edge region are angled away from the mouthpiece at an angle of at least 120° with respect to the central axis.

Aptly, a surface of the shield adjacent to the mouthpiece is substantially convex.

In this way, the shield provides ventilation between the infant's skin and the shield because there is no longer a moisture trap due to the close proximity of the inner surface of the shield and the infant's skin. Thus, drool or dribble from the infant's mouth does not stick between the face and the inner surface of the shield and can be easily wiped away or can easily evaporate. Also, moisture in the air from the infant's nose and mouth is able to flow freely away from the face.

The angled sections of the shield edge region also provide the shield with structural rigidity because their respective curvature gives the shield strength in more than one direction.

The increased rigidity provides further advantages in the soother design, because the greater strength allows for larger air-holes in the shield and hence the effective surface area of the shield may be minimised and weight may be reduced.

The improved ventilation and increased rigidity provided by the angled sections may be amplified by incorporating such sections on more than one radial segment of the shield. Thus, advantages for the shield design may apply equally in subsequent cross-sectional directions and the advantages on the shield as a whole may be reinforced.

With increased shield rigidity, the shield may be substantially lighter by making the shield thinner or providing air holes which comprise a large proportion of the shield area. Thus, the centre of gravity of the soother may be positioned towards the face of the user when they are sucking the mouthpiece. Accordingly, the soother may be more easily retained in the mouth.

Aptly, a surface of the shield opposite to the mouthpiece is substantially concave.

Aptly, each of the first and second sections of the shield edge region extends substantially transverse to the curve of each side portion.

Aptly, each of the first and second sections of the shield edge region slopes at a constant angle to the central axis.

Aptly, each of the first and second sections of the shield edge region forms a continuous path around an edge of the respective side portion.

In this way, the angled sections may surround the centre portion and the rigidity of the shield may be improved in every radial direction.

Aptly, each side portion curves continuously from the centre portion to the respective section of the shield edge region.

In this way, the shield is provided with an inner surface without any angles or edges that may cause injury.

Aptly, at least one section of the shield edge region comprises a reinforcing rib.

In this way, the shield may be further reduced in thickness or area without losing strength.

Aptly, the reinforcing rib is provided on a surface of the shield opposite to the mouthpiece.

Aptly, the first and second side portions each comprises a pair of wing portions, each pair of wing portions opposingly arranged either side of the centre portion.

Aptly, the shield edge region comprises the first and second sections and an upper and lower section, wherein the first, second, upper and lower sections of the shield edge region together form a single continuous path around an edge of the shield, and wherein the path slopes at a constant angle with respect to the central axis.

Aptly, the shield includes an upper portion arranged between the first and second side portions and configured to curve away from the mouthpiece towards an upper section of the shield edge region, wherein the upper section of the shield edge region slopes away from the mouthpiece at an angle of at least 120° with respect to the central axis.

Aptly, the shield includes a lower portion arranged between the first and second side portions and configured to curve away from the mouthpiece towards a lower section of the shield edge region which slopes away from the mouthpiece at an angle of at least 120° with respect to the central axis.

Aptly, the upper section of the shield edge region is arranged to extend between and join together the first and second sections of the shield edge region.

Aptly, the lower section of the shield edge region is arranged to extend between and join together the first and second sections of the shield edge region.

Aptly, at least one section of the shield edge region slopes at an angle of from 130° to 160° with respect to the central axis.

Aptly, each side portion comprises an air hole extending therethrough.

Aptly, the air holes each have a cross-sectional area and wherein the aggregate cross-sectional area of the air holes is at least 25% of a footprint area of the shield.

Aptly, the shield is a rigid frame co-moulded or over-moulded with a flexible material.

Aptly, the flexible material also forms at least one of the mouthpiece and a handle.

Aptly, the mouthpiece is operably retained in the shield by a plug.

Aptly, at least the mouthpiece and the shield are formed as unitary part.

According to another aspect of the present disclosure, there is provided a shield for an infant soother, the shield comprising:
a centre portion with a central axis therethrough, first and second side portions opposingly arranged either side of the centre portion, and a shield edge region distal from the centre portion;
wherein the centre portion comprises a first surface configured for mounting of a mouthpiece thereto;
wherein the first side portion is configured to curve away from the first surface of the centre portion towards a first section of the shield edge region, and the second side portion is configured to curve away from the first surface of the centre portion towards a second section of the shield edge region; and
wherein each of the first and second sections of the shield edge region are angled away from the first surface of the centre portion at an angle of at least 120° with respect to the central axis.

According to a further aspect of the present disclosure, there is provided a method of manufacturing an infant soother, the method comprising:
forming a shield comprising a centre portion with a central axis therethrough, first and second side portions opposingly arranged either side of the centre portion, and a shield edge region distal from the centre portion;

mounting a mouthpiece to the centre portion, the mouthpiece for insertion into an infant's mouth;
wherein the shield is formed such that the first side portion is configured to curve away from the mouthpiece towards a first section of the shield edge region, and the second side portion is configured to curve away from the mouthpiece towards a second section of the shield edge region; and such that each of the first and second sections of the shield edge region are angled away from the mouthpiece at an angle of at least 120° with respect to the central axis.

It will be appreciated that any of the features described above in relation to the first aspect of the invention may apply equally to the second or third aspects of the invention. That is, any features described above under the first aspect may be combined with the shield of the second aspect or with the method of the third aspect.

### BRIEF DESCRIPTION OF THE DRAWINGS

Embodiments of the invention are now described, by way of example only, with reference to the accompanying drawings, in which:

FIG. 1a shows a top view of a known soother;

FIG. 1b shows a cross-sectional side view of the soother of FIG. 1a,

FIG. 2a shows front perspective view of a first example of a soother;

FIG. 2b shows a rear perspective view of the soother of FIG. 2a;

FIG. 3a shows a diagonal cross-sectional side view through section C-C of the soother of FIG. 2a;

FIG. 3b shows a horizontal cross-sectional view through section X-X of the soother of FIG. 2a;

FIG. 3c shows a vertical cross-sectional view through section Y-Y of the soother of FIG. 2a;

FIG. 4 shows a front view of an example of a shield of a soother;

FIG. 5 shows a front perspective view of a second example of a soother;

FIG. 6 shows a cross-sectional view of the soother of either FIG. 2a or FIG. 5 in use in an infant's mouth; and

FIG. 7 shows a further cross-sectional view of the soother of FIG. 2a.

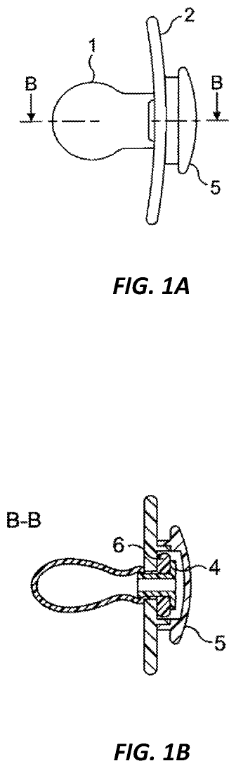

In the drawings, like reference numerals refer to like parts.

### DETAILED DESCRIPTION

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’ and ‘outer’, ‘outwardly’ refer to directions toward and away from, respectively, a designated centreline or a geometric centre of an element being described (e.g. central axis), the particular meaning being readily apparent from the context of the description.

Further, unless otherwise specified, the use of ordinal adjectives, such as, ‘first’, ‘second’, ‘third’ etc. merely indicate that different instances of like objects are being referred to and are not intended to imply that the objects so described must be in a given sequence, either temporally, spatially, in ranking or in any other manner.

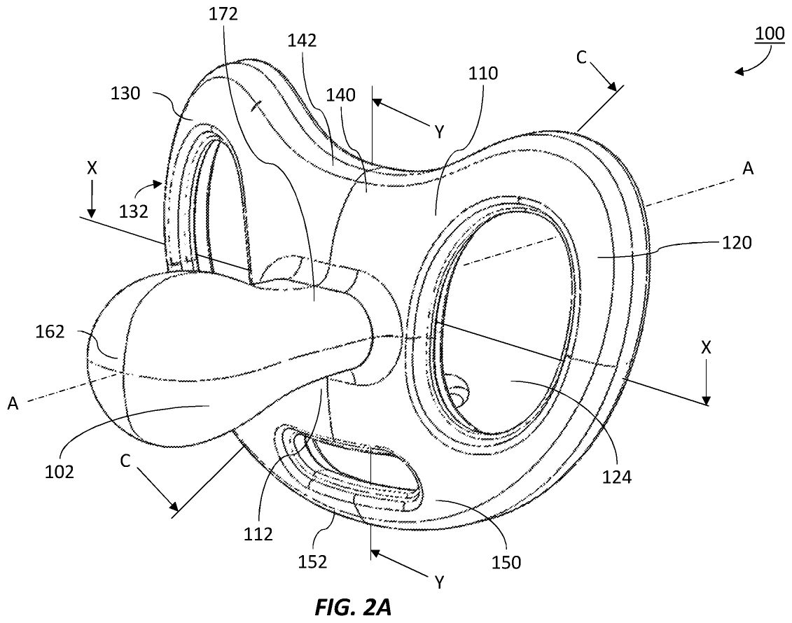

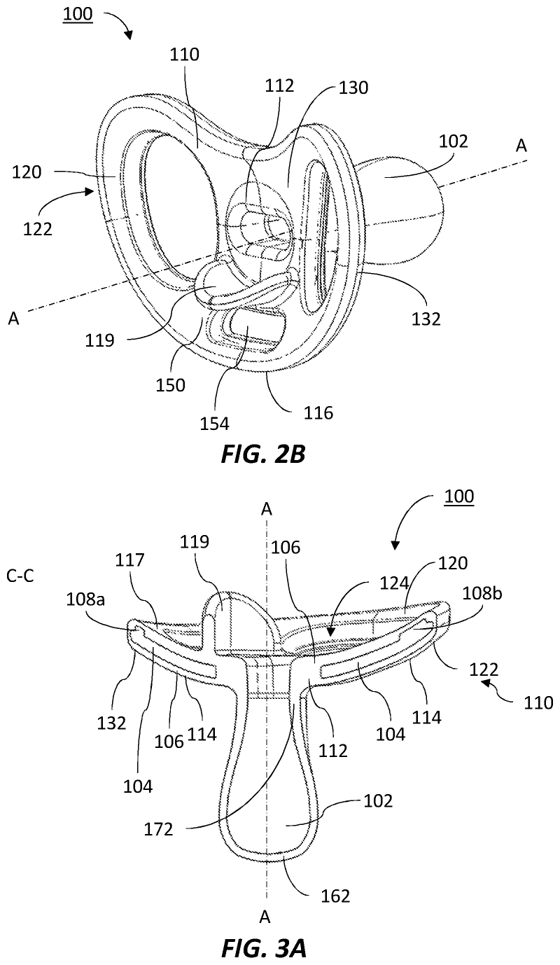

Referring now to FIGS. 2a and 2b, a soother 100 includes a curved shield 110 and a mouthpiece. In this example, the mouthpiece is a teat 102 for insertion into an infant's mouth.

The teat 102 is mounted to the shield 110 so that it extends away from a convex side of the shield 110 along a central axis A. In this way, the teat 102 is arranged so that a first end 162 is adjacent to the shield and a tip 172 is distal from the first end 162 and the shield 110. The shield 110 and the teat 102 each have an axial length.

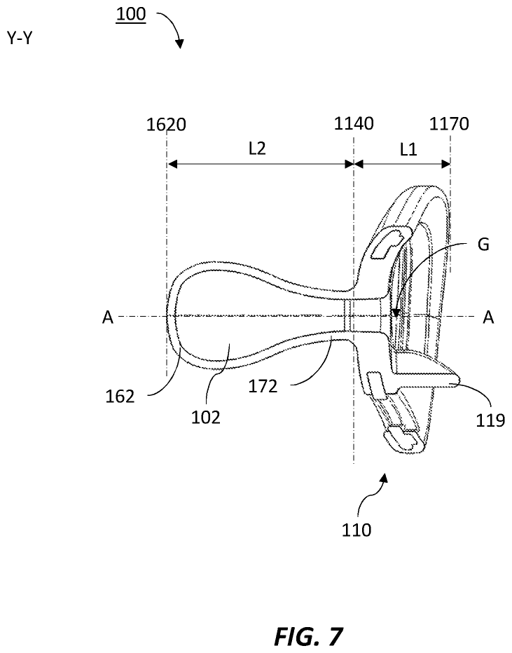

The soother 100 is configured so that its centre of gravity is in a region which extends from the tip 172 of the teat 102, along the axial length of the teat 102 and along up to 50% of the axial length of the shield 110. In this way, the centre of gravity of the shield is positioned relatively close to the infant's face, in use, and helps to prevent the soother falling from the infant's mouth. The position of the centre of gravity is discussed further below with reference to FIG. 7.

In the example shown, the shield 110 includes a centre portion 112 with the central axis A therethrough and a shield edge region distal from the centre portion 112. That is, the central axis A is substantially perpendicular to the shield at the centre portion 112. The shield edge region may form the outer edge region of the shield 110.

In this example, the teat 102 is mounted onto the centre portion 112 of the shield 110, such that the teat 102 projects away from the shield 110 along the central axis A of the shield 110. Aptly, the centre portion 112 may be flat or substantially flat. The teat is aptly mounted onto a first surface of the centre portion, which is configured for mounting of a mouthpiece thereto.

The shield may include first and second side portions 120, 130 arranged on opposing sides of the centre portion 112. The first and second side portions 120, 130 extend away from the centre portion 112 and curve away from the teat 102. In other words, the first and second side portions 120, 130 curve away from the first surface of the centre portion. In this way, the first and second side portions 120, 130 curve away from the teat 102 and towards the central axis A on the opposing side of the shield 110. In some examples, the first and second side portions 120, 130 may include wings.

The first and second side portions 120, 130 are both shaped to extend away from the centre portion 112 towards respective first and second sections of the shield edge region 122, 132. The first and second sections of the shield edge region 122, 132 are positioned distal from the centre portion 112 on opposing sides of the shield 110. As the first and second side portions 120, 130 extend away from the centre portion 112 they each curve away from the teat 102 until they each reach the respective section of the shield edge region 122, 132.

In this example, the first and second sections of the shield edge region 122, 132 are each angled away from the teat 102 at an angle of 130° with respect to the central axis A extending through the teat 102. That is, the angle between each of the first and second sections of the shield edge region with respect to the portion of the central axis A on the teat side of the shield is 130°.

In other words, the first and second sections of the shield edge region are inclined away from the mouthpiece at an angle of 130° with respect to the central axis A. This angle may alternatively be defined as 50° with respect to the central axis A on the side of the shield opposite to the teat 102.

In other examples, different angles of inclination of the first and second sections of the shield edge region may be used. For example, the first and second sections of the shield edge region may aptly be angled away from the teat (or other mouthpiece) at an angle of at least 120°, or from 120° to 160°, or from 130° to 160°, or from 130° to 150° with respect to the central axis.

In the example shown, the shield edge regions 122, 132 are arranged near the edge 116 of the shield inner surface 114. As such, when the teat 102 is in the infant's mouth during use, the shield 110 curves away from the infant's skin.

The inner surface 114 of the shield 110, i.e. the surface of the shield adjacent the teat 102 or other mouthpiece is substantially convex. In other words, the surface of the shield 110 facing the infant's face when the soother is being used, is substantially convex shaped with respect to the face of the infant. In this way, the inner surface 114 forms the convex side of the shield 110, with the mouthpiece extending from the convex side of the shield.

The outer surface 117 of the shield 110, i.e. the surface of the shield 110 opposing the teat 102 or other mouthpiece is substantially concave. As such, in use, the outer surface 117 is substantially concave with respect to the infant's face.

In this example, the outer surface 117 is provided with a handle 119, projecting away from the centre portion 112 in an opposing direction to the teat 102. In other examples, a handle may be omitted, or may be provided by other means known in the art, for example operatively coupled to a plug which is mounted to the shield.

Each of the first and second sections of the shield edge region 122, 132 extends substantially transverse to the curve of each side portion 120, 130. In other words, the first and second sections of the shield edge region 122, 132 run substantially transverse to (or across) the curved section of the respective side portion. In this way, the first and second sections of the shield edge region 122,132 follow the outer edge 116 of the side portions of the shield 110. Thus, the first and second sections of the shield edge region 122, 132 extend in circumferential direction around the shield inner surface 114.

Each of the first and second sections of the shield edge region 122, 132 may slope at a constant angle with respect to the central axis A. For example, as each of the first and second sections of the shield edge region 122, 132 extend substantially transverse to the slope of the respective side portion they may each slope at a constant angle with respect to the central axis A. In this way, as the shield edge regions 122, 132 extend around the shield inner surface, they remain sloped with respect to the central axis A. Thus, the respective sections of shield edge regions 122, 132 remain at a constant angle of 50° with respect to the central axis A. As such, the shield edge regions 122, 132 of each side portion 120, 130 may form a generally frustoconical shape with respect to the central axis A.

The slope of each of the first and second sections of the shield edge region 122, 132 may be substantially linear (i.e. a constant gradient or angle with respect to the central axis). In other examples, the slope of each of the first and second sections of the shield edge region 122, 132 may be non-linear and have a non-constant gradient or angle with respect to the central axis A. For example, whilst the slope may be non-linear, the first and second sections of the shield edge region 122, 132 may slope away from the mouthpiece at an average angle of at least 120°, or from 120° to 160°, or from 130° to 160°, or from 130° to 150°, for example, 130° with respect to the central axis A extending through the teat 120.

As the first and second sections of shield edge regions 122, 132 extend around the shield inner surface they may each form a continuous path portion around the shield outer edge.

In one example, the first and second sections of shield edge regions 122, 132 may be joined together to form a single continuous path. The single continuous path may be provided around the edge of the shield. In an alternative, the single continuous path may be provided around the outer edge of the shield for only a portion of its length.

Or, alternatively again, the single continuous path may be provided radially inwards of the outer edge of the shield. In this way, the shield, or portions of the shield, may extend radially beyond the shield edge regions.

The shield 100 further includes an upper portion 140 arranged above the central portion 112, as well as a lower portion 150 arranged below the central portion 112. The upper and lower portions 140, 150 each join both side portions 120, 130 together.

In this example, the upper and lower portions 140, 150 each join both side portions 120, 130 together so that the shield 110 makes up a single unbroken shape—in this case a rounded heart shape.

In this example, in addition to the first and second side sections, the shield edge region further includes an upper section 142 and a lower section 152. Together, the first, second, upper and lower sections of the shield edge region may form a single continuous path around the edge of the shield. That is, together, the first and second sections 122, 132 and the upper and lower sections 142, 152 of the shield edge region extend and together form a single, continuous shield edge region of the shield 110. Aptly, the single continuous path may slope at a constant angle (for example 130°) with respect to the central axis A on the teat side of the shield.

In this example, the upper portion 140 of the shield 110 extends between the centre portion 112 and the upper section 142 of the shield edge region and the lower portion 150 of the shield extends between centre portion 112 and the lower section 152 of the shield edge region.

In various examples, the shield may be provided with a shield edge region including the first and second sections and the upper section and the lower section. However, in contrast to the example shown, the upper and lower sections of the shield edge region may each be formed without corresponding upper and lower portions of the shield. That is, the upper and lower portions of the shield may be omitted.

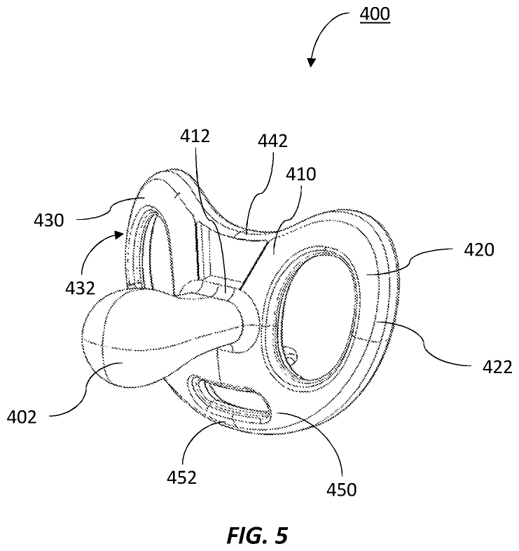

For example, as shown in FIG. 5, a second example soother 400 is substantially the same as the soother 100 of FIG. 2a, but the shield does not include an upper portion extending between the centre portion 412 and the upper section 442 of the shield edge region. Hence, the soother 400 includes a shield 410 and teat 402. The shield 410 includes first and second side portions 420, 430 as well as a lower portion 450. The shield 410 does not include any material between the centre portion 412 and the upper section 442 of the shield edge region. Nevertheless, the shield edge region includes first and second side sections 422, 432 of the first and second side portions as well as an upper section 442 and a lower section 452. Together, the first, second, upper and lower sections of the shield edge region form a single continuous path around the edge of the shield 410. That is, together, the first and second sections 422, 432 and the upper and lower sections 442, 452 of the shield edge region extend and together form a single, continuous shield edge region of the shield 110. Aptly, the single continuous path may slope at a constant angle (for example 130°) with respect to the central axis A on the teat side of the shield.

FIG. 7, shows the soother viewed through vertical cross-sectional axis Y-Y. The tip 162 of the teat 102 includes an outermost limit 1620 at the maximum axial distance from the shield 110. The shield 110 itself includes an innermost limit 1140 on the inner surface 114 of the shield, and an outermost limit 1170 on its outer surface 117. In the example shown, the handle 119 extends beyond the outermost limit 1170 of the shield.

The axial lengths of both the shield 110 and the teat 102 are defined along the direction of central axis A. The axial length L1 of the shield 110 is determined by the axial distance between its innermost and outermost limits 1140, 1170. The axial length L2 of the teat 102 is determined by the axial distance from the outermost limit 1620 of the tip 162 to the location at which first end 172 of the teat 102 joins the shield 110.

In the example shown, the innermost limit 1140 of the shield 110 includes the location at which the first end 172 of the teat 102 joins the shield 110. However, in other variations, the innermost limit may be at different axial position to the first end of the teat and, consequently, may be positioned closer to, or further away from the tip 162 than the first end 172.

The centre of the gravity G is lies substantially along the central axis A, spaced apart from the outer surface 117. The position of the centre of gravity may vary depending on factors of the soother design, as is explained in more detail below. In various examples, the centre of gravity may lie in a plane spaced apart from the central axis, for example vertically or horizontally away from the central axis. Additionally, or alternatively, the centre of gravity may lie in a position axially spaced from the body of the soother, or it may lie, for example, within the volume encompassed by the shield or even the mouthpiece.

As discussed above, the soother is configured such that the centre of gravity lies in a region, which extends from the tip 162 of the mouthpiece, along the axial length of the mouthpiece and along up to 50% of the axial length of the shield. It will be appreciated that the exact position of the centre of gravity within this region will vary according to the specific configuration of the components of the soother (e.g. the mouthpiece and the shield).

Aptly, the soother may be configured such that centre of gravity lies in a region which extends from the tip of the mouthpiece, along the axial length of the mouthpiece and along up to 35% of the axial length of the shield. More aptly the centre of gravity may lie in a region which extends from the tip of the mouthpiece, along the axial length of the mouthpiece, and along up to 25% of the axial length of the shield.

The region may alternatively begin at a different position along the axial length of the mouthpiece. For example, the region may extend from a mid-point of the axial length of the mouthpiece and along up to 50%, or 35% or 25% of the axial length of the shield.

In other examples, the centre of gravity may lie within the region defined by the axial length of the shield. For example, the soother may be configured such that the centre of gravity lies in a region which extends from the first end of the mouthpiece (or innermost limit of the shield) and along up to 50% or up to 35% or up to 25% of the axial length of the shield.

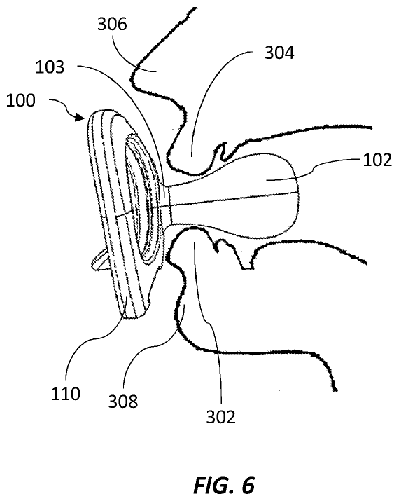

The example soother 100 of FIG. 2a is shown in use in FIG. 6. The following description with reference to FIG. 6 is equally applicable to the example soother 400 of FIG. 5.

As shown, in use the teat 102 is positioned within the infant's mouth 300 and may be sucked on by the infant. The soother 100 may be kept in place by upper and lower lips 302, 304 surrounding the narrowed neck 103 of the teat 102. In this position, the inner surface 114 of the shield 110 is sufficiently spaced from the face of the infant so that moisture cannot become trapped between the shield 110 and the skin surrounding the nose 306, the chin 308 or the cheeks (not shown).

Referring again to FIGS. 2a and 2b, in this example, the outer, concave surface 117 of the shield 110 is provided with a handle 119, projecting away from the centre portion 112 in an opposing direction to the teat 102.

The first and second side portions 120, 130 may each include an annular passage through the shield 110 defining air holes 124, 134. The air holes 124, 134 are provided for safety, as known in the art and described above.

The lower portion 150 is provided with a slot 154. The slot enables the soother to receive a strap or cord of a soother clip, also as known in the art.

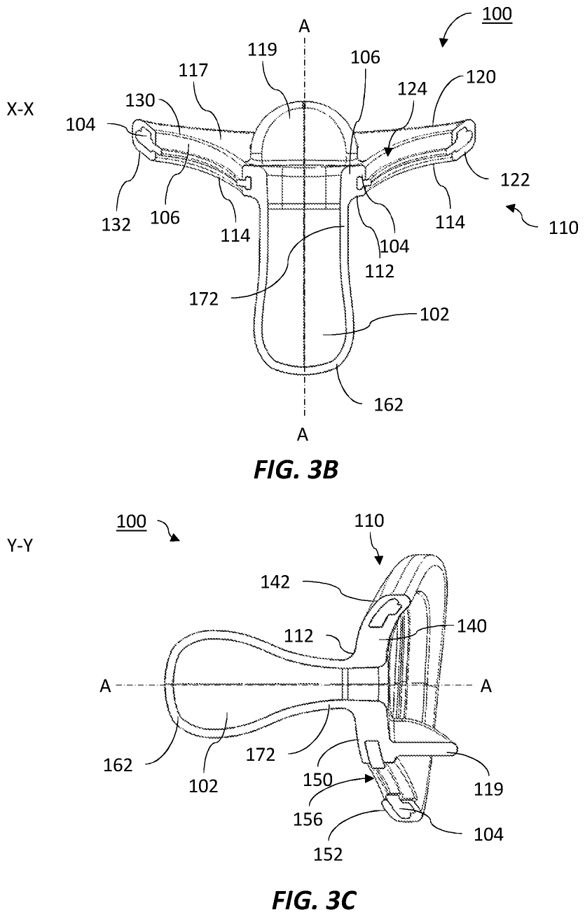

Further details about the construction and shape of the soother are described with reference to FIGS. 3a, 3b and 3c, which show cross-sectional axes C-C, X-X and Y-Y. Cross-sectional axis C-C is a diagonal cross-section through the shield 110; cross-sectional axis X-X is a horizontal cross-section; cross-sectional axis Y-Y is a vertical cross-section.

Taking cross-section C-C, as shown in FIG. 3a, the teat 102 is mounted to the centre portion 112 of the shield 110, at a point where the shield 110 extends radially away from and substantially orthogonal to the central axis A. The centre portion 112 is therefore at an angle with respect to the central axis A of 90°.

The first side portion 120 extends in a direction away from the centre portion 112. The first side portion 120 curves continuously from the centre portion 112 until it reaches a first section 122 of the shield edge region. In this way, the angle of the shield with respect to the central axis A on the teat side of the shield, and therefore the angle of the inner surface 114, increases from 90° at the central portion 112, to 130° at the first section 122 of the shield edge region.

The second side portion 130 extends in a direction away from the centre portion 112. The second side portion 120 curves continuously from the centre portion 112 towards the second section 132 of the shield edge region. The angle of the shield with respect to the central axis A therefore increases from an initial 90°, at the central portion 112, to 130° at the second section 132 of the shield edge region. Consequently, the angles of the first and second sections 122, 132 of the shield edge regions with respect to the central axis A are substantially the same.

As the cross-section C-C is taken across a diagonal radius of the shield, between the x- and y-axes of the shield 110, along this axis the first and second sections 122, 132 of the shield edge region are different radial distances away from the central axis A. Accordingly, along this cross-section, the first section 122 is radially further away than the second section 132 and therefore the curvature of the first side portion 120 is more gradual than the curvature of the second side portion 130.

Despite having different curvatures, the first and second shield edge regions are both angled at 130° with respect to the central axis A and thus sections of the shield 110 along cross-section C-C both curve well away from face. In this way, when in use, ventilation is provided between the infant's skin and the shield 110 because there is no longer a moisture trap due to the close proximity of the inner surface 114 with the face.

The first and second sections 122, 132 also provide the shield 110 with structural rigidity because their respective curvature gives the shield 110 strength in more than one direction. These curvatures would not otherwise be possible on traditional soother shields which curve towards the face because, to impart strength in this way, would produce a shield with an undesirable angled edge that could press against an infant's face and cause discomfort, or even injury.

The increased rigidity provides further advantages in the soother design, because the greater strength allows for larger air-holes and hence the effective surface area of the shield 110 may be minimised and weight may be reduced.

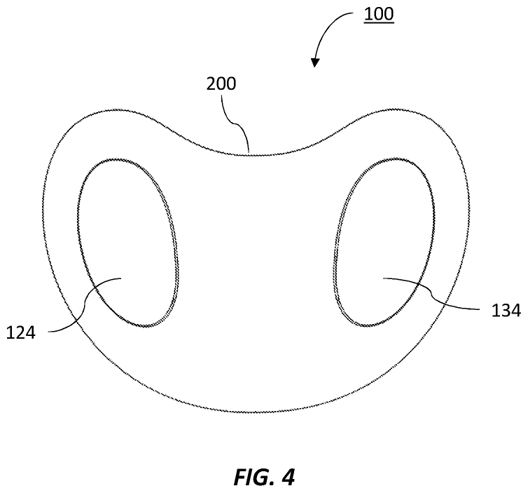

In other words, and with reference to FIG. 4, although the footprint 200 of the shape of the shield 110 is defined by its outline shape, the proportion of the footprint area taken up by the shield material may be significantly reduced because the cross-sectional area of the air holes 124, 134 are relatively large. Hence, the area of the air holes 124, 134 may form a substantial proportion of the overall footprint area of the shield 110 itself.

In various examples, the aggregate area of the air holes may form at least 25% of the area of the shield. In the present example, the air holes form approximately 30% of the area within the footprint 200 of the shield 110. As a consequence, the centre of gravity with respect to central axis A is closer to the face, helping to retain the soother in the mouth of the infant when in use.

In particular, and with reference to the cross-sectional view of FIG. 7, the centre of gravity G of the example soother 100 lies at an axial distance of 2.9 mm from the innermost limit 1140 of the shield and an axial distance of 10.7 mm from the outermost limit 1170 of the shield. The axial length of the shield is therefore 13.6 mm. The centre of gravity G therefore lies at a position along 21% of the axial length L1 of the shield, from the innermost limit 1140.

In a variation, the example soother may be slightly resized in order to be appropriate for infants of an older age group. When resized, the centre of gravity G of the example soother lies an axial distance of 2.5 mm from the innermost limit of the shield and an axial distance of 11.1 mm from the outermost limit 1170 of the shield. The axial length of the shield is therefore 13.6 mm. The centre of gravity G therefore lies at a position along 18% of the axial length L1 of the shield, from the innermost limit 1140.

The centre of gravity G of both example soothers thus lies significantly closer to the innermost limit 1140 of the shield 110 compared to outermost limit 1170. In use, the centre of gravity lies close to the user's face. In this way, the soother 100 will provide both improved ventilation, due to its convex shape, while ensuring the infant can easily retain the soother 100 in its mouth.

Additionally, or optionally, the shield thickness can be reduced to a minimum thereby making the soother lighter and therefore easier for the infant to keep in its mouth.

A further cross-sectional view of the side portions 120, 130 is described with reference to FIG. 3b in which the cross-section X-X passes through the air holes 124, 134. Thus, regions of the first and second side portions 120, 130 are absent. Nevertheless, the side portions each follow a curve from the centre portion 112 to the respective first section 122 and second section 132 of the shield edge region. In this way, despite the discontinuity of the air hole 124, the sections 122 and 132 are both angled away from the mouthpiece at 130° from the central axis A.

Along the cross-section X-X, the second section 132 of the shield edge region is radially equidistant from the central axis A as the first section 122. As a consequence, the side portions have the same curvature shape.

Because the first and second sections 122, 132, of the shield edge region across the cross-section X-X are also angled at 130° with respect to the central axis A, they enhance shield rigidity in substantially the same way as the sections 122, 132 in cross-section C-C. The rigidity is enhanced despite the presence of air holes 124, 134. Thus, advantages for the shield design described apply equally in the second cross-sectional direction and the beneficial effects on the shield 110 are reinforced.

The cross-sectional view Y-Y of the upper and lower portions 140, 150 is now described with reference to FIG. 3c. In this cross-section, the shield 110 curves tightly in its upper portion 140. The curve extends to the upper section 142 of the shield edge region. Again, the surface of the upper section 142 is angled at 130° with respect to the central axis A.

The curvature of the upper portion 140 is the tightest of any radial cross-section of the shield 110. That is, the curvature of the upper portion 140 is the tightest or steepest when compared to each of the lower portion 150 or first and second side portions 120, 130. Consequently, the upper section 142 of the shield edge region is radially closer to the central axis A than any other section of shield edge region.

On the opposing side of the centre portion 112, the lower portion 150 of the shield 110 also curves away from the teat 102. The lower portion 150 curves to the lower section 152 of the shield edge region, also angled at 130° with respect to the central axis A. The curvature of the inner surface 114 in the lower section 152 includes a discontinuity due to the slot 156.

Again, because the first and second sections of the shield edge region across the cross-section Y-Y are also angled at 130° to the central axis, they enhance shield rigidity in the substantially same way as the sections in cross-sections C-C and X-X. Thus, the advantages for the shield design described above are further amplified because the shield has the additional angled sections 142, 152.

In the example soother, the shield edge regions 122, 132 142, 152 of the first and second side portions 120, 130 and the upper and lower portions 140, 150 join up to form a continuous path around the shield of constant angle with respect to the central axis A. The shield edge regions thereby provide an angled surface surrounding the centre portion 112. In this way, the rigidity of the shield 110 is improved in every radial direction.

As can be seen from FIGS. 3A to 3C, the degree of curvature of the shield may vary between the first and second side portions 120, 130 and the upper and lower portions 140, 150. For example, the curvature of the upper portion 140 may be tighter than the curvature of the lower portion 150 and first and second side portions 120, 130. In other words, the average radius of curvature of the upper portion 140 may be smaller than the average radius of curvature of any of the lower 150 and first and second side portions 120, 130 of the shield. This is because the upper section 142 of the shield edge region is positioned closer to the central axis A than the first, second and lower sections 122, 132, 152 of the shield edge region.

Aptly, the curvature of the lower portion 150 may be tighter than the curvature of the first and second side portions 120, 130 of the shield. In other words, the average radius of curvature of the lower portion 150 may be smaller than the average radius of curvature of any of the first and second side portions 120, 130 of the shield. This is because the lower section 152 of the shield edge region is positioned closer to the central axis A than the first and second sections 122, 132 of the shield edge region.

Aptly, the average radius of curvature of the first side portion 120 is the same as the average radius of curvature of the second side portion 130.

The inner surface 114 of the shield may be formed such that the radius of curvature gradually changes between the first and second and upper and lower portions 120, 130, 140, 150. In this way, the inner surface of the shield may be substantially smooth and convex in shape.

In some examples, the radius of curvature of any of the first and second and upper and lower portions 120, 130, 140, 150 of the shield may be larger at the centre portion 112 and gradually become smaller towards the respective section of the shield edge region. In other words, the curvatures of any of the first and second and upper and lower portions of the shield may become tighter towards the shield edge region.

The soother of the invention may be manufactured by various methods and techniques. As an example, the soother 100 is produced using a known over-moulding process in which the soother shield 110 is moulded from a first, rigid material in a first process. Once the rigid shield is formed, a second, flexible material is moulded on top of the first material.

In this example, the shield 110 includes a rigid frame 104 moulded from polybutylene terephthalate (PBT) in a first process to form the general shape of the shield, including an aperture in the frame to accommodate each of the air holes 124, 134, slot 154 and centre portion 112.

After being formed, the frame is substantially encapsulated in an over-moulded portion 106 via second moulding process. The over-moulded portion 106 may be made from silicone rubber. The over-moulded portion 106 may provide the inner and outer surfaces 114, 117 of the shield 110 and form the centre portion 112 of the shield 110 as well as the teat 102 and handle 119 of the soother 100. The inner surface 114 of the shield 110 is the surface facing the infant's face when the infant is sucking on the teat 102. As the silicone rubber is a relative soft grade, in this case hardness of Shore A 50, the soother has a soft feel.

Using this over-moulding method, the soother is formed with the mouthpiece and shield as a unitary part.

Various examples of soothers are possible. The described examples relates to a first soother in FIGS. 2 to 5 and second soother in FIG. 6. However, as mentioned above, “soother” is to be understood to include devices which are known as a comforter, teether, teething device, soother, dummy or pacifier. The mouthpiece may be a teat or it may be a shaped teething part or chewing portion, such as a ring or other suitably-shaped projection.

Various examples and configurations of shield edge regions are possible. For example, the shield edge region may be discontinuous around the shield, or it may have a non-constant (e.g. undulating or varying) angle with respect to the central axis.

In various examples it may be possible to provide only a single short section of shield edge region, and hence angled surface, on each side portion and still gain sufficiently increased rigidity to the shield overall.

In a various examples, the shield edge region may be provided in intermittent sections.

In various examples, the shield edge region may not be at the edge of the soother because additional features, such as aesthetic elements or soft edges are provided on the shield radially outside the shield edge region.

The side portions are described with intermediary upper and lower portions in order to provide a contiguous shield shape but many other shaped shields as appropriate to soothers may be provided and the side portions may be shaped accordingly but remain within the scope of the invention.

In various examples, the shield may be provided with only one of either an upper portion or a lower portion. The upper or lower portion may be arranged between the first and second side portions and curved away from the mouthpiece towards a respective upper or lower section of the shield edge region. The upper or lower section of the shield edge region may be arranged to slope at an angle of at least 120° with respect to the central axis. For example, at least one of the upper or lower section of the shield edge region may be arranged to slope at an angle of at least 120°, or from 120° to 160°, or from 130° to 160°, or from 130° to 150°, for example 130° with respect to the central axis.

In various examples, the side portions may meet and join without intermediary upper and lower portions. For example, the shield may be generally annular, or the side portions may each comprise a number of smaller wing portions. For example, the shield may be generally butterfly shaped. Or, again, the side portions may have irregular or asymmetrical outline shapes.

In various examples, the shield may be provided with a reinforcing feature, such as a rib. The reinforcing feature may be provided on at least one section of the shield edge region. Alternatively, or additionally, a reinforcing feature may be provided on the outer surface of the shield. Alternatively, or additionally, a reinforcing feature may be provided on the rigid frame of the shield and partially or completely over-moulded with a flexible over-mould portion, for example the shield may include a first rib 108a and second rib 108b of frame 104 in FIG. 3a.

As mentioned above, soothers which are heavy may fall out of the infant's mouth. In particular, retaining the soother relies on the infant keeping its upper and lower lips 302, 304 around the neck 103 of the teat 102 as it rests on its lower lip 302. If the shield is relatively heavy or is weighted away from the face then, for example where the infant is sitting upright, there is a tendency for the soother to want to pivot around the lower lip 302. The infant therefore has to actively close its jaw at all times while the teat is in its mouth in order to retain the soother. Thus a soother design which is heavy, or which moves the centre of gravity of the soother away from the face when it is being sucked would make it liable to fall out of the mouth.

As a consequence of the increased rigidity of the shield, the shield of the soother of the invention may be made considerably lighter by making it thinner or by providing air holes which comprise a large proportion of the shield area. In this way, the shield may be configured using a reduced mass of material in the shield as compared to the mouthpiece. In use, the soother is not overly weighted away from the face by a shield of excessive size and weight. Thus, the centre of gravity of the soother may not be adversely affected and, may be moved towards the face. Accordingly, the soother may be more easily retained in the mouth.

The use of air holes as discussed above can help to modify the position of the centre of gravity of the soother in the axial direction so that it can be positioned closer to the infant's face. The soother may include other features in addition to or instead of the air holes, which also help to position the centre of gravity closer to the infant's face.

For example, the weight of the shield relative to the mouthpiece may be reduced using features in addition to or instead of air holes. For example, the shield may include any one of a series of ribs or projections (e.g. distributed to move the centre of gravity towards to the mouthpiece), a series of channels or grooves (e.g. designed to reduce the weight of the outer portions of the shield). In other examples, the shield may be formed from or include a region or regions of discontinuous materials such as a honeycomb or reticulated structure or the like. In other examples, the shield may be formed from a material of relatively low density compared to the mouthpiece. These features may be used alone or in conjunction with each other. Each of the features may help to reduce the weight of the shield compared to the mouthpiece such that centre of gravity of the soother is positioned closer to the mouthpiece in the axial direction.

In a further variation, the soother may include a weighted mouthpiece. A weighted mouthpiece may be configured to balance or counteracts the weight of the shield of the soother to an extent that the centre of gravity lies close to the face of the user when in use (i.e. closer to the mouthpiece). In certain examples, such as with a hollow soother baglet, the mouthpiece may be weighted, for example by a thickening of the baglet walls, or by a thickening of the wall at the tip of the mouthpiece. In this way, a weighted mouthpiece may be provided without adding appreciable weight to the soother as a whole.

It will be clear to a person skilled in the art that features described in relation to any of the examples described above can be applicable interchangeably between the different examples. The examples described above are to illustrate various features of the invention.

Further embodiments of the invention are set out in the following clauses in which there is provided:
1. An infant soother comprising:
   a shield comprising a centre portion with a central axis therethrough, first and second side portions opposingly arranged either side of the centre portion, and a shield edge region distal from the centre portion;
   a mouthpiece mounted to the centre portion for insertion into an infant's mouth;
   wherein the first side portion is configured to curve away from the mouthpiece towards a first section of the shield edge region, and the second side portion is configured to curve away from the mouthpiece towards a second section of the shield edge region; and
   wherein each of the first and second sections of the shield edge region are angled away from the mouthpiece at an angle of at least 120° with respect to the central axis.
2. An infant soother according to clause 1, wherein a surface of the shield adjacent to the mouthpiece is substantially convex.
3. An infant soother according to clause 1 or clause 2, wherein a surface of the shield opposite to the mouthpiece is substantially concave.
4. An infant soother according any preceding clause, wherein each of the first and second sections of the shield edge region extends substantially transverse to the curve of each side portion.
5. An infant soother according to any preceding clause, wherein each of the first and second sections of the shield edge region slopes at a constant angle with respect to the central axis.
6. An infant soother according to any preceding clause, wherein each of the first and second sections of the shield edge region forms a continuous path portion around an edge of the respective side portion.
7. An infant soother according to any preceding clause, wherein each side portion curves continuously from the centre portion to the respective section of the shield edge region.
8. An infant soother according to any preceding clause, wherein at least one section of the shield edge region comprises a reinforcing rib.
9. An infant soother according to clause 8, wherein the reinforcing rib is provided on a surface of the shield opposite to the mouthpiece.
10. An infant soother according to any preceding clause, wherein each of the first and second side portions comprises a pair of wing portions, each pair of wing portions opposingly arranged either side of the centre portion.
11. An infant soother according to any preceding clause, wherein the shield edge region comprises the first and second sections and an upper section and a lower section, wherein the first, second, upper and lower sections of the shield edge region together form a single continuous path around an edge of the shield, and wherein the path slopes at a constant angle with respect to the central axis.
12. An infant soother according to any preceding clause, wherein the shield further includes an upper portion arranged between the first and second side portions and configured to curve away from the mouthpiece towards an upper section of the shield edge region, wherein the upper section of the shield edge region slopes away from the mouthpiece at an angle of at least 120° with respect to the central axis.
13. An infant soother according to clause 12, wherein the upper section of the shield edge region is arranged to extend between and join together the first and second sections of the shield edge region.
14. An infant soother according to any preceding clause, wherein the shield further includes a lower portion arranged between the first and second side portions and configured to curve away from the mouthpiece towards a lower section of the shield edge region, wherein the lower section of the shield edge region slopes away from the mouthpiece at an angle of at least 120° with respect to the central axis.
15. An infant soother according to clause 14, wherein the lower section of the shield edge region is arranged to extend between and join together the first and second sections of the shield edge region.
16. An infant soother according to any preceding clause, wherein at least one section of the shield edge region slopes away from the mouthpiece at an angle of from 130° to 160° with respect to the central axis.
17. An infant soother according to any preceding clause, wherein each side portion comprises an air hole extending therethrough.
18. An infant soother according to clause 17, wherein the air holes each have a cross-sectional area and wherein the aggregate cross-sectional area of the air holes is at least 25% of a footprint area of the shield.
19. An infant soother according to any preceding clause, wherein the shield is a rigid frame co-moulded or over-moulded with a flexible material.
20. An infant soother according to clause 19, wherein the flexible material also forms at least one of the mouthpiece and a handle.
21. An infant soother according to any of clauses 1 to 18, wherein the mouthpiece is operably retained in the shield by a plug.
22. An infant soother according to any of clauses 1 to 18, wherein at least the mouthpiece and the shield are formed as a unitary part.
23. A shield for an infant soother, the shield comprising:
   a centre portion with a central axis therethrough, first and second side portions opposingly arranged either side of the centre portion, and a shield edge region distal from the centre portion;
   wherein the centre portion comprises a first surface configured for mounting of a mouthpiece thereto;
   wherein the first side portion is configured to curve away from the first surface of the centre portion towards a first section of the shield edge region, and the second side portion is configured to curve away from the first surface of the centre portion towards a second section of the shield edge region; and
   wherein each of the first and second sections of the shield edge region are angled away from the first surface of the centre portion at an angle of at least 120° with respect to the central axis.
24. A method of manufacturing an infant soother, the method comprising:
   forming a shield comprising a centre portion with a central axis therethrough, first and second side portions opposingly arranged either side of the centre portion, and a shield edge region distal from the centre portion;
   mounting a mouthpiece to the centre portion, the mouthpiece for insertion into an infant's mouth;
   wherein the shield is formed such that the first side portion is configured to curve away from the mouthpiece towards a first section of the shield edge region, and the second side portion is configured to curve away from the mouthpiece towards a second section of the shield edge region; and such that each of the first and second sections of the shield edge region are angled away from the mouthpiece at an angle of at least 120° with respect to the central axis.

1. An infant pacifier comprising:
a curved shield having a central axis extending therethrough,
a mouthpiece extending from a substantially convex side of the shield and along the central axis, for insertion into an infant's mouth, wherein the mouthpiece comprises a first end adjacent to the shield and a tip distal from the shield;
wherein the shield and the mouthpiece each have an axial length, and
wherein the pacifier is configured such that a center of gravity of the pacifier lies in a region which extends from the tip of the mouthpiece, along the axial length of the mouthpiece and along up to 50% of the axial length of the shield.

2. An infant pacifier according to claim 1, wherein the shield comprises a center portion with the central axis therethrough, first and second side portions opposingly arranged either side of the center portion, and a shield edge region distal from the center portion.

3. An infant pacifier according to claim 2, wherein the mouthpiece is mounted to the center portion of the shield.

4. An infant pacifier according to claim 2, wherein the first side portion is configured to curve away from the mouthpiece towards a first section of the shield edge region, and the second side portion is configured to curve away from the mouthpiece towards a second section of the shield edge region.

5. An infant pacifier according to claim 4, wherein each of the first and second sections of the shield edge region are angled away from the mouthpiece at an angle of at least 120° with respect to the central axis.

6. An infant pacifier according to claim 4, wherein at least one section of the shield edge region slopes away from the mouthpiece at an angle of from 130° to 160° with respect to the central axis.

7. An infant pacifier according to claim 1, wherein the shield further comprises a substantially concave side, opposingly arranged to the substantially convex side.

8. An infant pacifier according to claim 7, wherein the substantially concave side comprises at least one of: a series of ribs, a series of channels or grooves, a series of projections or a region of discontinuous material.

9. An infant pacifier according to claim 7, wherein the substantially concave side includes at least one reinforcing rib.

10. An infant pacifier according to claim 1, wherein the mouthpiece is weighted such that a weight of the mouthpiece is greater than a weight of the shield.

11. An infant pacifier according to claim 1, wherein the curved shield comprises at least one air hole extending therethrough.

12. An infant pacifier according to claim 11, wherein each air hole each has a cross-sectional area and wherein the aggregate cross-sectional area of the air holes is at least 25% of a footprint area of the shield.

13. An infant pacifier according to claim 1, wherein the curved shield is a rigid frame co-moulded or over-moulded with a flexible material.

14. An infant pacifier according to claim 13, wherein the flexible material also forms at least one of the mouthpiece and a handle.

15. An infant pacifier according to claim 1, wherein at least the mouthpiece and the shield are formed as a unitary part.

16. An infant pacifier according to claim 1, wherein the center of gravity lies in a region which extends from the first end of the mouthpiece along up to 35% of the axial length of the shield.

17. An infant pacifier according to claim 1, wherein the center of gravity lies in a region which extends from the first end of the mouthpiece along up to 25% of the axial length of the shield.

18. An infant pacifier according to claim 1, wherein the axial length of the shield is at least 10 mm.

19. (canceled)

20. An infant pacifier comprising:
a curved shield having a central axis extending therethrough,
a mouthpiece extending from a substantially convex side of the shield and along the central axis, for insertion into an infant's mouth, wherein the mouthpiece comprises a first end adjacent to and adjoining the shield and a tip distal from the shield;
wherein the shield has an axial length extending between innermost and outermost axial limits, and
wherein the pacifier is configured such that a center of gravity of the pacifier lies in a region which extends from an innermost limit of the shield along up to 50% of the axial length of the shield.

21. A method of manufacturing an infant pacifier, the method comprising:
forming a curved shield having a central axis extending therethrough, mounting a mouthpiece to a substantially convex side of the shield and along the central axis, for insertion into an infant's mouth, wherein the mouthpiece comprises a first end adjacent to the shield and a tip distal from the shield;
wherein the shield and the mouthpiece each have an axial length, and
wherein the pacifier is configured such that a center of gravity of the pacifier lies in a region which extends from the tip of the mouthpiece, along the axial length of the mouthpiece and along up to 50% of the axial length of the shield.
